(19) United States
(12) Patent Application Publication
(10) Pub. No.: US 2015/0193829 A1
(43) Pub. Date: Jul. 9, 2015

(54) SYSTEMS AND METHODS FOR PERSONALIZED IMAGES FOR AN ITEM OFFERED TO A USER

(71) Applicant: Partha Sarathi Mukherjee, San Jose, CA (US)

(72) Inventor: Partha Sarathi Mukherjee, San Jose, CA (US)

(21) Appl. No.: 14/147,358

(22) Filed: Jan. 3, 2014

(51) Int. Cl. G06Q 30/02; G06T 11/60

(52) U.S. Cl. CPC G06Q 30/0271; G06T 11/60

(57) ABSTRACT

There is provided systems and method for personalized images for an item offered to a user. A user may upload one or more user images to a server, or the server may access the image from another online source. The user images may include a portrait of the user, such as a facial portrait or a full body portrait. The images may then be used to create personalized images using the portrait and an image of an item. For example, the image may be used in place of a stock image of an actor or other generic person in an advertisement to show the product or service offered in the advertisement with the user instead. Additionally, the image may be utilized for account features as well, such as a security feature, where the image is displayed on entry of a username for a user account of the user.

### TECHNICAL FIELD

Example embodiments of the present application relate generally to personalized images for an item offered to a user, and more specifically to receiving an image including a portrait of the user's likeness and generating a personalized image, such as an advertisement for an item, using the image an another image of the item.

### BACKGROUND

Users possessing user accounts with one or more entities may establish and/or receive specific user account elements by virtue of holding the user account. User account elements may include account name, login, security features associated with the account (e.g., password, password protection, CAPTCHA-type challenge tests, etc.), account preferences, and/or services offered by an account provider (e.g., sale services, payment services, etc.). These account elements may be useful for a user; however, they may only provide the user with general information. For example, an account element offering login features may simply request a user name and password from a user. Additionally, advertisements involved with the services offered by an account may include generic images that are of little or no help to a user in deciding whether to purchase an offered item. The generic images may not be appealing to the user on their own, or may provide an image that is so dissimilar to what a user would imagine their use of the product or service would be that it provides no help to the user.

Modern user devices include high resolution device cameras that are able to take and edit photographs of a user. The user may upload these photographs to user accounts that provide a variety of services. For example, some user account may allow the user to share the photograph with friends. Other user accounts may provide for editing of photographs by the user. However, the editing is usually done by a user or a specialist with certain instructions from the user. Thus, a user wishing to view their likeness in a different pose or image must either engage in editing or request the services from a professional.

### BRIEF DESCRIPTION OF THE DRAWINGS

FIG. 1 is a block diagram of a networked system suitable for implementing the processes described herein, according to an embodiment;

FIG. 2A is an exemplary server providing personalized advertisement image generated using an advertisement and a user image, according to an embodiment;

FIG. 2B is an exemplary user interface displaying a personalized advertisement image generated from a user image, according to an embodiment;

FIG. 3 is an exemplary user interface displaying a personalized security feature using a user image, according to an embodiment;

FIG. 4 is a flowchart of an exemplary process for providing personalized account elements using a user image, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for personalized images for an item offered to a user. Systems suitable for practicing methods of the present disclosure are also provided.

A user, such as a consumer possessing a user account, may establish the user account with a server offering user account services. Exemplary servers offering user account services may include merchant servers, payment provider servers, email servers, or other online entities allowing a user to establish a user account and utilize services offered by the entity. Once the user has established a user account, the user may further utilize the services offered through the user account, such as shopping, issuing/receiving payments, or other services. The user may utilize a user device to access the user account, such as through a browser application of the user device or a dedicated application corresponding to the server (e.g., a payment application offered by a payment provider server).

Additionally, the user device may include a device camera enabling the user to capture images. The user may utilize the device camera to capture an image of the user's likeness, such as a portrait of the user. The portrait may correspond to a facial portrait or a full body portrait of the user. The user may further capture more than one orientation of the portrait, such as sides, below, and above the face. In various embodiments, the user may also capture another user in the image, such as a family member or friend.

The user may then upload these images to the server offering the user account services. The images may be utilized to provide personalized account elements to the user. An account element may be some feature offered by the user account. For example, an account element may correspond to images of items offered for sale through the account, such as advertisements for products and/or services that may be purchasable using the user account. Another account element may correspond to security features of the account. In other embodiments, account elements may be any feature or service offered using the user account.

After the user has uploaded images to the user account, the server may personalize the account elements by processing the account element using the image. The processed account element may then display the image. Where the account element corresponds to an advertisement containing a stock image of another user or a predetermined place to insert an image, the advertisement may be processed using the image so that the advertisement displays the portrait of the user. Where the account element corresponds to a security feature, the account element may display the portrait of the user on entry of a user name, and instruct the user to only enter a password if the user recognizes the portrait. Other account elements may display the image as well, such as account backgrounds, account displays/identifiers/names/handles, service advertisements (e.g., a virtual trial of a service), or other account elements. Where the product or service includes more than one user in the advertisement or virtual trial, the portrait of the user's family and/or friends may be utilized in the account element as well. These personalized account elements may then be transmitted to the user so the user obtains personalized account settings.

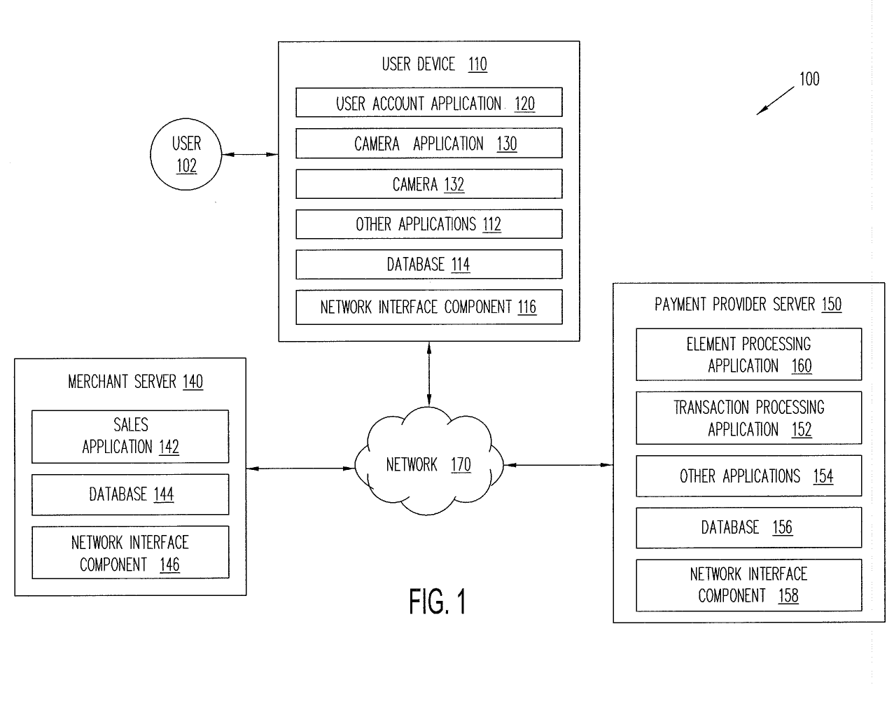

FIG. 1 is a block diagram of a networked system 100 suitable for implementing the processes described herein according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, a merchant server 140, and a payment provider server 150 in communication over a network 170. User 102, such as a consumer, may utilize user device 110 to access a user account with payment provider server 150. Additionally, user 102 may upload images containing a portrait of the user to payment provider server 150. Payment provider server 150 may utilize the images to create personalized account elements for the user account of user 102. Where the account elements correspond to advertisements (e.g., static or dynamic advertisements, such as images, videos, and/or virtual trials) of items offered by merchant server 140, payment provider server 150 may receive the advertisements from merchant server 140. The advertisements may contain stock images/portraits that may be processed using the images of user 102 to provide personalized account elements. In other embodiments, payment provider server 150 may process an account element provided by payment provider server 150, such as a security feature, with the image.

User device 110, merchant server 140, and payment provider server 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

User device 110 may be implemented using any appropriate hardware and software configured for wired and/or wireless communication with merchant server 140 and/or payment provider server 150 over network 170. In one embodiment, user device 110 may be implemented as a personal computer (PC), a smart phone, personal digital assistant (PDA), laptop computer, wristwatch with appropriate computer hardware resources, eyeglasses with appropriate computer hardware (e.g., GOOGLE GLASS®) and/or other types of computing devices capable of transmitting and/or receiving data, such as an IPAD® from APPLE®. Although a user device is shown, the user device may be managed or controlled by any suitable processing device. Although only one user device is shown, a plurality of user devices may be utilized.

User device 110 of FIG. 1 contains a user account application 120, a camera application 130, a camera 132, other applications 112, a database 114, and a network interface component 116. User account application 120, camera application 130, and other applications 112 may correspond to processes, procedures, and/or applications executable by a hardware processor, for example, a software program. In other embodiments, user device 110 may include additional or different software as required.

User account application 120 may be used, for example, to provide a convenient interface to permit user 102 to create, access, and maintain a user account with a user account provider, such as payment provider server 150. User 102 may utilize user account application 120 to initially access payment provider server 150 and create a user account. User 102 may submit information, including at least a user name and a password to create the user account. Once the user account is created with payment provider server 150, user 102 may utilize user account application 120 to access and maintain the user account. While user account application 120 is described as a dedicated account application of payment provider server 150 (e.g., an application offered by payment provider server 150, for example, through a download available from payment provider server 150), in other embodiments user account application 120 may correspond to a browser application to access a website of payment provider server 150 over network 170.

User 102 may also utilize user account application 120 to upload images to payment provider server 150 for use with a user account. User 102 may capture images using a camera of user device 110, such as camera 132. Images may include a portrait of user 102, including a facial portrait, full-body portrait, and/or more than one perspective image of the portrait for multiple orientations (e.g., sides, top, bottom, back, etc.). Once user 102 has transmitted images to payment provider server 150, the images may be utilized to generate personalized account elements, as will be explained in more detail herein.

Once the personalized account elements have been generated by payment provider server 150, the personalized account elements may be transmitted for reception by user device 110. User account application 120 may then display the personalized account element to user 102. Where the personalized account elements correspond to personalized advertisements displaying an image of user 102 in place of a stock image (e.g., an image of an actor or silhouette frame to place a user image), the personalized advertisements may displayed on accessing the user account. In other embodiments, the personalized account element may correspond to a security feature that is displayable prior to accessing the user account, for example, while entering a username and/or password for the user account.

User account application 120 may also provide social networking services, email services, and/or other services having messaging, posting, or other communication services. Such services may be utilized to provide personalized account elements. For example, user account application 120 may provide messaging services, where user 102 is represented by an image, video, avatar, or similar that displays the user 102's likeness using the image(s) uploaded by user 102.

User 102 may further utilize user account application 120 to enter payment options for storage by user device 110, provide payment for an item with merchant server 140 and/or payment provider server 150, and complete the payment for the item with merchant server 140 and/or payment provider server 150. For example, where a personalized account element corresponds to an advertisement for an item available with merchant server 140, user account application 120 may provide payment for the item using stored payment information. Thus, user account application 120 may utilize user financial information, such as a credit card, bank account, or other financial account, to generate and/or complete purchase requests for items contained in a personalized advertisement. In other embodiments, user account application 120 may provide payment for items using the user account with payment provider server 150. User account application 120 may include cross-linking, allowing user 102 to identify a separate payment account, for example, identifying a user account through a debit card account number. User account application 120 may further include options to store transaction histories for purchased items, such as receipts, for later use. Thus, user account application 120 provides an interface enabling user 102 to provide proof of purchase of an item.

In certain embodiments, user account application 120 may include options to transmit user preferences corresponding to items user 102 would like to purchase. The user preferences may be utilized by payment provider server 150 to generate the personalized advertisements, as will be discussed in more detail herein. User account application 120 may receive user preferences from direct user input. Additionally, user account application 120 may receive user preferences from another application of user device 110. User account application 120 may scrape user preferences from other sources, such as online user accounts/profiles, social networking accounts and/or postings, blogging/microblogging services, email applications etc. User account application 120 may also save user searches for items with merchant server 140 and transmit to payment provider server 150.

Camera application 130 may be configured to provide an application to capture images using a device camera of user device 110, such as camera 132. Camera application 130 may provide additionally processing after capturing an image, including cropping, adjusting color/saturation/resolution, or other editing procedures. Camera application 130 may utilize functions associated with camera 132, such as flash, zoom, image resolution, or other camera parameter. Additionally, camera application 130 may provide for creating, accessing, and editing a library of images, such as a photo book of captured images stored in database 114. The library and/or individual images may be accessible by one or more other applications, including user account application 120, through an API of camera application 130. Images captured by camera 132 may correspond to still images and/or video images.

Camera 132 corresponds to an optical device of user device 110 enabling user 102 to record images, including still and/or video images. Camera 132 may correspond to a digital camera on a user device, or may more generally correspond to any device capable of recording an image. Camera 132 may include various features, such as zoom, flash, focus correction, shutter speed controls, or other various features usable to capture one or more images of user 102 and/or other users. Camera 132 may further display a preview and/or captured image to user 102 through another device of user device 110, such as a viewfinder, screen (e.g., mobile phone screen), or other display.

User 102 may utilize camera 132 with camera application 130 to record a still image and/or video image containing a likeness of user 102. For example, the captured image may contain a portrait of user 102, such as a facial and/or full body portrait of user 102. In various embodiments, more than one captured image may be utilized to obtain images of multiple perspectives of user 102's portrait. The multiple images may correspond to orientation of user 102, such as side, top, bottom, back, etc. Additionally, user 102 may record additional users in the image in order to utilize the multiple users in the personalized account element.

User device 110 includes other applications 112 as may be desired in particular embodiments to provide features to user device 110. For example, other applications 112 may include security applications for implementing client-side security features, programmatic client applications for interfacing with appropriate application programming interfaces (APIs) over network 170, or other types of applications. Other applications 112 may also include email, texting, voice, IM, and/or social networking applications that allow a user to send and receive emails, calls, texts, messages, postings, and other notifications through network 170, where the aforementioned function may not be provided by user account application 120. In various embodiments, other applications 112 may include financial applications, such as banking, online payments, money transfer, or other applications associated with payment provider server 150. Additionally, other application may include browser applications, mapping/check-in applications, and/or social networking applications. Other applications 112 may contain other software programs, executable by a processor, including a graphical user interface (GUI) configured to provide an interface to the user.

User device 110 may further include database 114 which may include, for example, identifiers such as operating system registry entries, cookies associated with user account application 120, camera application 130, and/or other applications 112, identifiers associated with hardware of user device 110 including camera 132, or other appropriate identifiers, such as identifiers used for payment/user/device authentication or identification. In one embodiment, identifiers in database 114 may be used by user device 110, merchant server 140, and/or payment provider server 150, to associate user device 110 with a particular account maintained by merchant server 140 and/or payment provider server 150.

Database 114 may include user personal information (e.g., a name, social security number, user financial information, or other identifying information), a user account identifiers (e.g., at least one of a user identifier, a user credit or debit card number, a user account name, and a user account number), and/or a user device identifier that may be utilized to identify user 102 and/or user device 110. In various embodiments, database 114 may include online account access information. Database 114 may store user information from user input, various applications of user device 110, and/or scrapped from sources such as other applications, online user accounts/profiles, etc. Database 114 may further store user images generated using camera 132 and/or processed with camera application 130. User images may be stored singly, or collectively in one or more photo books comprising a set of images. User images in database 114 may further include images of user 102, including a portrait of a likeness of user 102, such as a facial portrait and/or full body portrait. User images may further include one or more other users with user 102, such as family and/or friends.

In various embodiments, user device 110 includes at least one network interface component 116 adapted to communicate with merchant server 140 and/or payment provider server 150 over network 170. Network interface component 116 may include a DSL (e.g., Digital Subscriber Line) modem, a PSTN (Public Switched Telephone Network) modem, an Ethernet device, a broadband device, a satellite device and/or various other types of wired and/or wireless network communication devices. In various embodiments, network interface component 116 may include a communication module for short range communications including microwave, radio frequency, infrared, Bluetooth, and near field communication devices.

Merchant server 140 may be maintained, for example, by a merchant or seller offering various items (e.g., goods, products, events, and/or services) through an online site or application. In certain embodiments, merchant server 140 may include a corresponding merchant location for redemption of an item purchase (e.g., a merchant storefront, venue, etc.). Generally, merchant server 140 may be maintained by anyone or any entity that receives money, which includes charities as well as retailers and restaurants. In this regard, merchant server 140 may include processing applications, which may be configured to interact with user device 110 and payment provider server 150 to facilitate the advertisement and sale of items. In various embodiments, merchant server 140 may correspond to EBAY®, Inc. of San Jose, Calif., USA. However, in other embodiments, merchant server 140 may correspond to any merchant offering items and/or services to user 102. Merchant server 140 may include applications to facilitate the exchange of money and the transmission of transaction histories to the purchaser.

Merchant server 140 may be implemented using any appropriate hardware and software configured for wired and/or wireless communication with user device 110 and/or payment provider server 150. For example, in one embodiment, merchant server 140 may be implemented as a single or networked server computing system, personal computer (PC), a smart phone, personal digital assistant (PDA), laptop computer, and/or other types of computing devices capable of transmitting and/or receiving data. Although a merchant server is shown, the merchant server may be managed or controlled by any suitable processing device. Although only one merchant server is shown, a plurality of merchant servers may be utilized

Merchant server 140 includes a sales application 142, a database 144, and a network interface component 146. Sales application 142 may correspond to processes, procedures, and/or applications executable by a hardware processor, for example, a software program. In other embodiments, merchant server 140 may include additional or different software as required.

Sales application 142 may correspond to an application to serve information to user device 110 and/or payment provider server 150 over network 170. User 102 may interact with sales application 142 to view various items available for purchase from merchant server 140. Thus, sales application 142 may include an interface displayable on user device 110. In various embodiments, sales application 142 may correspond to a marketplace where a plurality of users and/or merchants may sell items. Sales application 142 may offer services similar to EBAY®, Inc. of San Jose, Calif., USA. However, sales application 142 may correspond more generally to any application enabling merchant server 140 to offer items for sale to user 102. Items available from sales application 142 may correspond to products, goods, services, event admissions, or other available items.

Sales application 142 may include items for sale, purchase prices of the items, inventory of the items, and/or terms of purchase. Additionally, sales application 142 may further track information about sales and prices of items available with merchant server 130. For example, sales application 142 may adjust and/or track sale prices and inventory levels as purchases are made. In addition to sales information for items available with merchant server 140, sales application 142 may include advertisements (e.g., still image advertisements, video advertisements, and virtual trials), advertisement information, and other promotional information for items available with merchant server 140. The advertisements may include stock images replaceable with one or more images of user 102. The stock images may correspond to a blank area for entry of the images of user 102 and/or a stock image of an actor that is replaceable with the image(s) of user 102.

In addition to being accessible directly by user device 110, payment provider server 150 may request advertisements for items available with merchant 140 from sale application 142 through accessing an API of sales application 142. Payment provider server 150 may request/receive advertisements, advertisement information, and/or item sale information (e.g., price, inventory, description) for an item from sales application 142. Sales application 142 may also be configured to interact with payment provider server 150 to complete purchase requests for items available with sales application 142.

Merchant server 140 includes a database 144 identifying available products, goods, and/or services (collectively referred to as items) which may be made available for viewing and purchase through sales application 142 and/or personalized advertisements provided by payment provider server 150. Database 144 may include tracking numbers for the items, stock amounts, prices, and other item information. Database 144 may further include analytics of items, such as high trending items (e.g., large amount of purchases, searches, items with discounts, etc.), price variations including price predictors, inventory levels, and/or other desired item information. Database 144 may further include advertisements for items (e.g., still, video, and virtual trial advertisements), advertisement information, and/or other promotional information (including sale prices, coupons, or other price saving promotions). Information in database 144 may be utilized by payment provider server 150 in creating personalized advertisements, as will be explained in more detail herein.

In various embodiments, merchant server 140 includes at least one network interface component 146 adapted to communicate with user device 110 and/or payment provider server 150 over network 170. Network interface component 146 may include a DSL (e.g., Digital Subscriber Line) modem, a PSTN (Public Switched Telephone Network) modem, an Ethernet device, a broadband device, a satellite device and/or various other types of wired and/or wireless network communication devices. In various embodiments, network interface component 146 may include a communication module for short range communications including microwave, radio frequency, infrared, Bluetooth, and near field communication devices for communication.

Payment provider server 150 may be maintained, for example, by an online payment service provider, which may provide personalized account elements and payment services on behalf of user 102 and other users. In this regard, payment provider server 150 includes one or more processing applications, which may provide payment for items between user device 110 and merchant server 140. In one example, payment provider server 150 may be provided by PAYPAL®, Inc. of San Jose, Calif., USA. However, in other embodiments, payment provider server 150 may be maintained by or include a merchant, financial services provider, and/or other service provider, which may provide user account services to user 102. Although payment provider server 150 is described as separate from merchant server 140, it is understood that merchant server 140 may include services offered by payment provider server 150 and vice versa.

Payment provider server 150 of FIG. 1 includes an element processing application 160, a transaction processing application 152, other applications 154, a database 156, and a network interface component 158. Element processing application 160, transaction processing application 152, and other applications 154 may correspond to processes, procedures, and/or applications executable by a hardware processor, for example, a software program. In other embodiments, payment provider server 150 may include additional or different software as required.

Payment provider server 150 includes element processing application 160, which may be configured to generate at least one personalized account element for a user account of user 102, wherein the personalized account element displays a portrait of user 102 from an image uploaded by user 102. Thus, element processing application 160 may be configured to receive images of user 102, as discussed with respect to user account application 120, camera application 130, and camera 132 of user device 110. Once element processing application 160 receives at least one user image including a portrait of the user, element processing application 160 may store the image and/or use the image to process an account element with the image to generate a personalized account element. Additionally, element processing application 160 may receive information from sales application 142 (for example through accessing an API of sales application 142 and requesting/receiving information) corresponding to an item available with merchant server 130. Information received from sales application 142 may correspond to one or more items, item descriptions, item pricings, item inventory levels, and corresponding item advertisement and advertisement information.

In various embodiments, element processing application 160 may personalize the account element to user 102 by personalizing a feature of the account, such as a security feature, email/chat/messaging feature, or visual account feature (e.g., a background, theme, etc.). Element processing application 160 may personalize a security feature of the user account by utilizing the image uploaded by user 102 during a login process for the user account. For example, after user 102 enters a username for the account, the image may be displayed to user 102. The user may be instructed to only enter a password if the user recognizes the image. This process may only occur after user 102 has previously logged in using the current device user 102 is utilizing (e.g., user device 110). Thus, if user 102 has not previously used user device 110, entering the username may start a process to authorize user device 110, including security checks, additional security questions for user 102, and/or other security measures.

In other embodiments, images uploaded to payment provider server 140 may be utilized to provide personalized advertisements to user 102. As previously discussed, personalized advertisements may be a still image advertisement of an item (e.g., product or service), a video advertisement, an interactive advertisement (e.g., interactive game, slideshow, etc.), and/or a virtual trial. Personalized advertisements may be generated by utilizing an image including a portrait of user 102 in place of a stock image of an actor in the advertisement or in a place meant to receive a portrait of user 102 (e.g., a silhouette area meant to accept an image or part of an image). In other embodiments, an image of the item from the advertisement may be applied to the portrait. The advertisement may be processed using the portrait of the user to create the personalized account element. Where an advertisement is not available for the item, a sale of the item may be processed with the user portrait to generate a personalized account element. For example, a picture of the item may be superimposed on the portrait, and sale information may be utilized with the image to generate a personalized account element corresponding to the sale of the item.

User preferences may guide a choice of account elements to personalize using images of user 102. Where the account element corresponds to a sale of a product, such as an advertisement, user preferences may determine a list of advertisements to personalize for user 102. User preferences may correspond to input by user 102, or user preferences determined from information corresponding to user 102. Information corresponding to user 102 may correspond to past purchases by user 102, travel or location information about user 102 (e.g., a travel destination, information about a location of user 102, etc.), previous user searches, or other user information.

Transaction processing application 152 may be configured to receive information from user device 110 and/or merchant server 140 for processing and completion of financial transactions. Transaction processing application 152 may include one or more applications to process financial transactions between user device 110 and/or merchant server 140. Financial transactions may include financial information may correspond to user debit/credit card information, checking account information, a user account (e.g., payment account with payment provider server 150), or other payment information. Transaction processing application 152 may complete the financial transaction for the purchase request by providing payment to merchant server 140. In various embodiments, transaction processing application 152 may provide transaction histories, including receipts, to user device 110 in order to provide proof of purchase for an item. Transaction processing application 152 may also provide the transaction histories to mobile merchant 140 for use in delivery of the item.

In various embodiments, payment provider server 150 includes other applications 154 as may be desired in particular embodiments to provide features to payment provider server 150. For example, other applications 154 may include security applications for implementing server-side security features, programmatic server applications for interfacing with appropriate application programming interfaces (APIs) over network 170, or other types of applications. Other applications 154 may contain software programs, executable by a processor, including a graphical user interface (GUI), configured to provide an interface to a user.

Additionally, payment provider server 150 includes database 156. As previously discussed, user 102 may establish one or more user accounts with payment provider server 150. User accounts in database 156 may include user information, such as name, address, birthdate, payment/funding information, additional user financial information, and/or other desired user data. Data with user accounts in database 156 may further include uploaded images corresponding to user 102, such as self-portraits and portraits of other users. Additionally, user accounts in database 156 may be further associated with one or more personalized account element. User 102 may link user accounts to user device 110 through a user device identifier. Thus, when a device identifier corresponding to user device 110 is transmitted to payment provider server 150, e.g., from user device 110 and/or merchant server 140, a user account belonging to user 102 may be identified. In other embodiments, user 102 may not have previously established a user account and may utilize an account management application of payment provider server 150 to create one.

In various embodiments, payment provider server 150 includes at least one network interface component 158 adapted to communicate with user device 110 and/or merchant server 140 over network 170. In various embodiments, network interface component 158 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

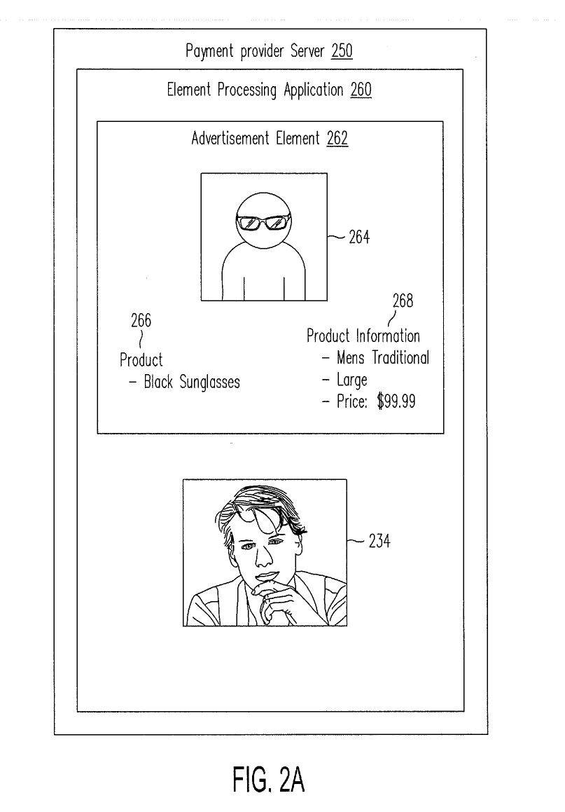

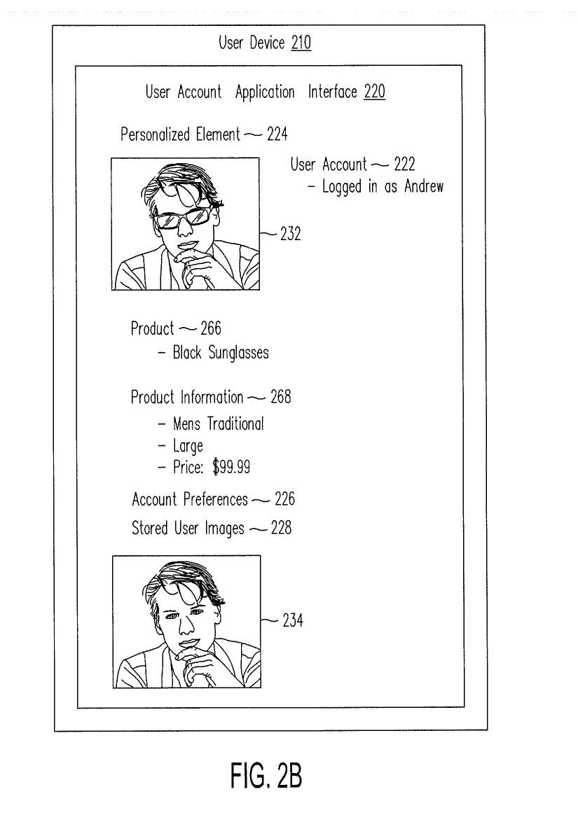

FIG. 2A is an exemplary server providing personalized advertisement image generated using an advertisement and a user image, according to an embodiment. FIG. 2A includes a payment provider server 250 and an element processing application 260 corresponding generally to payment provider server 150 and element processing application 160, respectively, of FIG. 1.

In FIG. 2A, payment provider server 250 executes element processing application 260 to process advertisement element 262 using user image 234. Advertisement element 262 includes a stock image 264, a product 266, and product information 268. Product 266 may correspond to a product name or brief product description, in FIG. 2A shown as “Black Sunglasses.” Product 266 may also be displayed in stock image 264, for example, as the black sunglasses on the silhouette in FIG. 2A. Additionally, product information 268 may include a product description, size, inventory, price, or other relevant information to a user wishing to purchase product 266. Both product 266 and product information 268 may correspond to user preferences, where the user preferences guide payment provider server 250 in choosing product 266 having product information 268.

Stock image 264 of advertisement element 262 may correspond to an image that has been associated with an advertisement of advertisement element 262. For example, an advertiser generating advertisement element 262 may utilize a stock image of an actor in product 266. In other embodiments, stock image 264 may correspond to a silhouette or other background meant to frame or other present product 266. Stock image 264 may be designated with borders that are removable by element processing application 260. Product 266 displayed in stock image 264 may also be removable from stock image 264. However, in other embodiments, element processing application 260 may process stock image 264 to remove the background image and/or the image of product 266, or inset user image 234 in stock image 264.

Element processing application 260 may then process the image of product 266 in stock image 264 with user image 234 to obtain a personalized image of product 266 with the user in user image 234. As previously discussed, a user may upload one or more images of the user including a portrait of the user. User image 234 of FIG. 2A includes a facial portrait of the user. Utilizing the image of product 266 in stock image 264, the image of product 266 may then be displayed on the user in user image 234, as shown in FIG. 2B. User image 234 may also be obtained through other means, such as through a user's social network service, microblogging service, or other available sources on the Internet or third party databases. Thus, even if a user does not have any images stored with the user account or on the user device, personalized images of advertisements (i.e., a personalized advertisement) may be presented. Note that the personalized advertisements may be sent to the user, such as through email, but may also be offerings from a merchant or commerce site. For example, when the user enters a merchant online website and the website recognizes the user, such as through a login, IP address, or other means, the user is presented with personalized images of the site offerings. For example, the website may have a webpage of different sports jerseys. Conventionally, the user might see stock photos of models wearing the jerseys. According to one embodiment of the present invention, the user now sees the user's face and/or body wearing the jerseys.

In another embodiment, personalized images for items may be determined by the system. For example, if the system knows the user may be interesting in purchasing something for a grandson (knowing the user has a grandson and the grandson's birthday is coming up or Christmas is coming up), the user may be presented with advertisements with the image of the user's grandson. Thus, user preferences may guide selection of product 266 and product information 268, as previously discussed. Selection of advertisements may be done by scraping user preferences from other online sources, such as social networking account, microblogging account, and/or other user accounts online (e.g., an email account, payment account, etc.). Moreover, user preferences may be transmitted to payment provider server 250 from user data on a user device, including information stored with other applications on the user device. Past user purchases may also be utilized for user preferences, as well as seasonal information, financial information, and the like.

FIG. 2B is an exemplary user interface displaying a personalized advertisement image generated from a user image, according to an embodiment. FIG. 2B includes user device 210 and user account application interface 220 corresponding generally to user device 110 and user account application 120, respectively, of FIG. 1.

FIG. 2B includes user device 210 displaying user account application interface 220 to a user, where user account application interface 220 includes a personalized advertisement image. User account application interface 220 includes user account 222 showing user account information to the user of user device 210. User account 222 includes login information for the user so the user may view the user account name and other account information. User account 222 may further include a logout button and/or other information corresponding to user account 222. User account 222 may further include account preferences 226 and stored user images 228. Account preferences 226 may be utilized to set user preferences corresponding to desired items and/or advertisements for use in determining personalized advertisements. As previously discussed in reference to FIG. 2A, account preferences 226 may include user preferences determined from past purchases, scraped from other sources, and/or received from user input and/or other applications of user device 210. Account preferences 225 may also determine which account elements to personalize (e.g., a user may select to personalize all advertisements for an item offered to the user, a part of the advertisements, or another feature of user account 222). Additionally, account preferences 226 may also include a selection of one or more of stored user images 228 to utilize for personalized account elements. Stored user image 228 may correspond to one or more images uploaded by the user of user device 210 to payment provider server 250 of FIG. 2A for use in creating personalized element 224.

User account application interface 220 includes personalized element 224, product 266, and product information 268. Product 266 and product information 268 may correspond to the same or similar information presented in product 266 and product information 268 of FIG. 2A. However, as shown in FIG. 2B, personalized element 224 displays the image of product 266, from stock image 264 of FIG. 2A, on user image 234 of FIG. 2A. Thus, personalized element 224 displays an image of the user of user device 210 with an image of product 266. Personalized element 224 thus corresponds to a personalized image of a user generated using an image of an item. Personalized element 224 may allow the user to view an example of the product and/or service with an image of the user for more personalized advertisements. In various embodiments, where multiple orientations of the user are uploaded as stored user images 228, a plurality of images, potentially showing different perspectives/orientations of the user, may be utilized to generate personalized element 224. Although FIG. 2B shows personalized element 224 with a product (i.e. sunglasses in FIG. 2B), other products and/or services may be shown. For example, an image of the user may be processed with a vacation brochure, hairstyle, or other service.

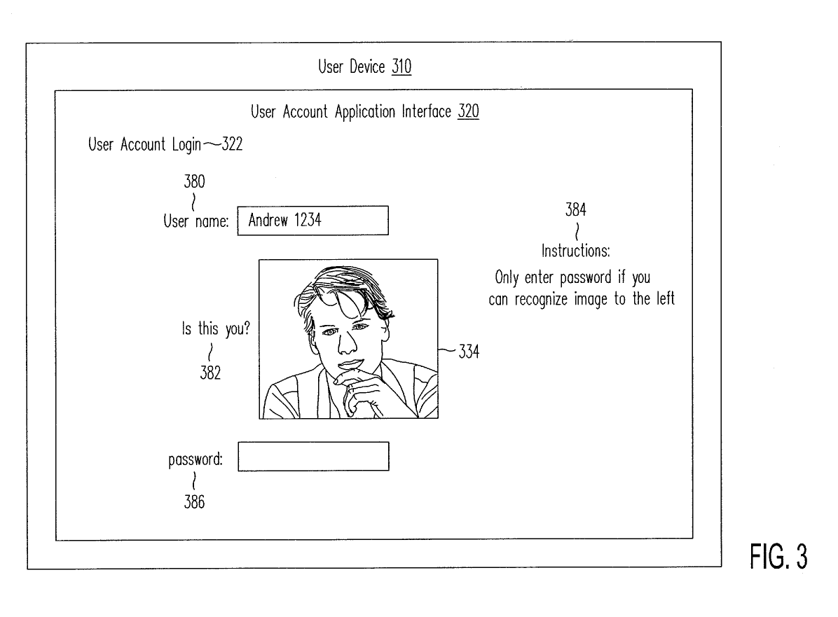

FIG. 3 is an exemplary user interface displaying a personalized security feature using a user image, according to an embodiment. FIG. 3 displays a user device 310 and a user account application interface 320 corresponding generally to user device 110 and user account application 120, respectively, of FIG. 1.

User device 310 displays user account application interface 320 having a user account login 322 displaying a user account login page/request. User account login 322 includes username field 380, an authentication request 382, a user image 334, instructions 384, and a password field 386. User account login 322 displays a user account login page/request where user device 310 has previously been used to access the user account of user account login 322. For example, on entry of the username in username field 380, if user device 310 has previously been utilized to access a user account corresponding to the user name, authentication request 382, user image 334, and instructions 384 will populate. However, if user device 310 has not previously been utilized to the user account, user account application interface 320 may be utilized to request additional security information from a user of user device 310 and/or conduct security checks on user device 310 and/or the user.

If user device 310 has previously been utilized to access the user account, then authentication request 382, user image 334, and instructions 384 are displayed in user account application interface 320. Authentication requests 382 displays a question to the user of user device 310 asking the user to identify user image 334. Additionally, instructions 382 include instruction for the user to corresponding identification of user image 334. Thus, if the user does recognize user image 334, the user should enter a password in password field 386. Therefore, in FIG. 3, user image 334 acts as a personalized security feature for a user account.

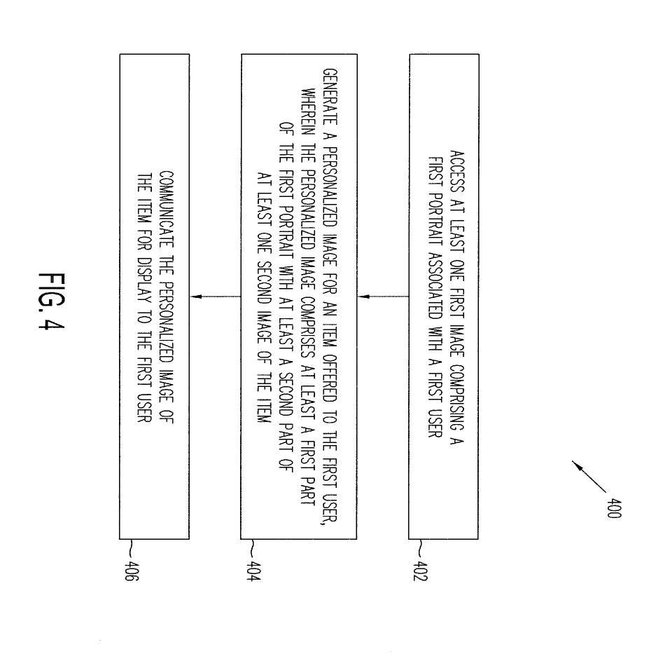

FIG. 4 is a flowchart of an exemplary process for providing personalized account elements using a user image, according to an embodiment. Note that one or more steps, processes, and methods described herein may be omitted, performed in a different sequence, or combined as desired or appropriate.

At step 402, at least one image comprising a first portrait of a first user is received. The first portrait of the first user may comprise a facial portrait or a full body portrait. Additionally, more than one image may be received, where images may include multiple orientations/perspectives of the first user to more fully develop a personalized account element of the first user. In addition to the first user, the image may further comprise a second portrait of a second user, such as a friend or family member that may also be utilized in the personalized account element(s).

An account element corresponding to a user account of the first user is processed using the image to generate a personalized account element, at step 404, wherein the personalized account element displays at least a first part of the first portrait. The account element may comprise a sale of a product or a service to a first user. Thus, the personalized account element may be the sale of the product or the service using the likeness of the first user in the image. More specifically, where the sale comprises an advertisement, a personalized account element generated from the advertisement may display the first portrait of the first user while using/wearing/operating/etc. the product or the service offered in the advertisement. For example, the advertisement may include a stock portrait, such as a generic portrait of an actor, where the personalized account element generated from the first portrait of the first user and the advertisement uses the first portrait of the first user in place of the stock portrait. However, the sale may be more general than an advertisement, such as an offer for sale, a coupon, a rebate, or a price discount for the item or the service.

In other embodiments, the account element may comprise a security feature of the user account, where the personalized account feature generated using the security feature and the first portrait of the first user displays the first portrait of the first user after entry of a username for the user account. In response to entry of the username, instruction and a request for a password may be transmitted to the user device if the user device has been previously used to access the user account, wherein the instructions comprise a request to enter the password if the user recognizes the personalized account element displaying the portrait of the first user.

At step 406, the personalized account element is transmitted for display to the first user. The first user may utilize the user device to view the personalized account element. Thus, the first user may receive more personalized account elements using images of the first user.

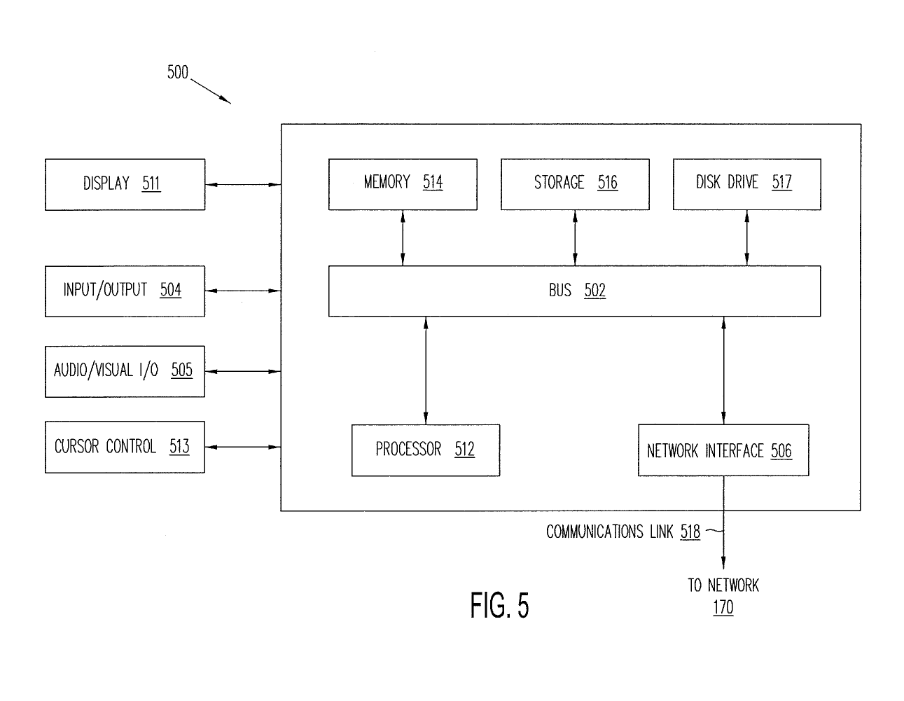

FIG. 5 is a block diagram of a computer system suitable for implementing one or more components in FIG. 1, according to an embodiment. In various embodiments, the user device may comprise a personal computing device (e.g., smart phone, a computing tablet, a personal computer, laptop, PDA, Bluetooth device, key FOB, badge, etc.) capable of communicating with the network. The merchant server and/or service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, a merchant server, or a service provider server via network 170. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing user information for a first user; and
one or more hardware processors in communication with the non-transitory memory and configured to:
access at least one first image comprising a first portrait associated with the first user;
generate a personalized image for an item offered to the first user, wherein the personalized image comprises at least a first part of the first portrait with at least a second part of at least one second image of the item; and
communicate the personalized image of the item for display to the first user.

2. The system of claim 1, wherein the at least one first image further comprises a second portrait associated with a second user.

3. The system of claim 2, wherein the one or more hardware processors is further configured to:
determine one of the first portrait and the second portrait from the at least one first image to use for the personalized image

4. The system of claim 2, wherein the personalized image further comprises at least a third part of the second portrait of the second user.

5. The system of claim 1, wherein the first portrait of the first user comprises a facial portrait or a full body portrait, and wherein the personalized image comprises the facial portrait or the full body portrait.

6. The system of claim 1, wherein the at least one first image comprises a plurality of images of different perspectives of the first portrait of the first user.

7. The system of claim 1, wherein the at least one second image of the item comprises an advertisement for a product or a service corresponding to the item.

8. The system of claim 7, wherein the advertisement comprises a stock portrait, and wherein the personalized image uses the first portrait of the first user in place of the stock portrait.

9. The system of claim 1, wherein the personalized image of the item is displayed on a web page of a merchant offering the item.

10. The system of claim 1, wherein the at least one first image is accessed from one of a social networking service, a microblogging service, and a user account associated with the first user.

11. The system of claim 1, wherein the one or more hardware processors is further configured to:
store the at least one first image with at least one of an IP address associated with the first user, a user device identifier associated with the first user, and a user account identifier associated with the first user.

12. A method comprising:
accessing at least one first image comprising a first portrait associated with the first user;
generating, using one or more hardware processors of a server, a personalized image for an item offered to the first user, wherein the personalized image comprises at least a first part of the first portrait with at least a second part of at least one second image of the item; and
communicating the personalized image of the item for display to the first user.

13. The method of claim 12, wherein the at least one first image further comprises a second portrait associated with a second user, and wherein the personalized image further comprises at least a third part of the second portrait of the second user.

14. The method of claim 12, wherein the at least one first image comprises a plurality of images of different perspectives of the first portrait of the first user.

15. The method of claim 12, wherein the at least one image comprises a plurality of images of different perspectives of the first portrait of the first user.

16. The method of claim 12, wherein the at least one second image of the item comprises an advertisement for a product or a service corresponding to the item.

17. The method of claim 12, wherein the at least one first image is accessed from one of a social networking service, a microblogging service, and a user account associated with the first user.

18. The method of claim 12 further comprising:
storing the at least one first image with at least one of an IP address associated with the first user, a user device identifier associated with the first user, and a user account identifier associated with the first user.

19. A non-transitory computer readable medium comprising a plurality of machine-readable instructions which when executed by one or more processors of a server are adapted to cause the server to perform a method comprising:
accessing at least one first image comprising a first portrait associated with the first user;
generating a personalized image for an item offered to the first user, wherein the personalized image comprises at least a first part of the first portrait with at least a second part of at least one second image of the item;
communicating the personalized image of the item for display to the first user; and
storing the at least one first image with at least one of an IP address associated with the first user, a user device identifier associated with the first user, and a user account identifier associated with the first user.

20. The non-transitory computer readable medium of claim 19, wherein the at least one second image of the item comprises an advertisement for a product or a service corresponding to the item, and wherein the advertisement comprises a stock portrait, and wherein the personalized image uses the first portrait of the first user in place of the stock portrait.
